(19) United States
(12) Patent Application Publication
(10) Pub. No.: US 2024/0397472 A1
(43) Pub. Date: Nov. 28, 2024

(54) SIDELINK POSITIONING SCHEMES IN WIRELESS COMMUNICATIONS

(71) Applicant: ZTE Corporation, Shenzhen (CN)

(72) Inventors: Mengzhen LI, Shenzhen (CN); Chuangxin JIANG, Shenzhen (CN); Juan LIU, Shenzhen (CN); Hanqing XU, Shenzhen (CN); Shujuan ZHANG, Shenzhen (CN); Junpeng LOU, Shenzhen (CN)

(21) Appl. No.: 18/793,343

(22) Filed: Aug. 2, 2024

Related U.S. Application Data
(63) Continuation of application No. PCT/CN2022/085750, filed on Apr. 8, 2022.

(51) Int. Cl. H04W 64/00; H04L 5/00

(52) U.S. Cl. CPC H04W 64/00; H04L 5/0051

(57) ABSTRACT

A method of wireless communication is described. The wireless communication method includes initiating, by a network device, positioning services for a user device, and configuring, by a network device, sidelink positioning reference signal (SL-PRS) resources for the positioning services.

### CROSS REFERENCE TO RELATED APPLICATIONS

This patent document is a continuation of and claims benefit of priority to International Patent Application No. PCT/CN2022/085750, filed on Apr. 8, 2022. The entire content of the before-mentioned patent application is incorporated by reference as part of the disclosure of this application.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for feedback schemes for multiple channels in wireless communication devices.

In one aspect, a wireless communication method is disclosed. The method of wireless communication includes initiating, by a network device, positioning services for a user device, and configuring, by a network device, sidelink positioning reference signal (SL-PRS) resources for the positioning services.

In another aspect, a wireless communication method is disclosed. The method of wireless communication includes receiving, by a user device, from a network device, sidelink positioning reference signal (SL-PRS) resource configuration, and transmitting, to another user device, one or more SL-PRS transmissions according to the SL-PRS configuration.

In another aspect, a communication apparatus comprising a processor configured to implement the above-described method is disclosed.

In another aspect, a computer readable medium having code stored thereon, the code, when executed, causing a processor to implement the above-described method is disclosed.

These, and other features, are described in the present document.

### BRIEF DESCRIPTION OF THE DRAWING

FIG. 1 shows an example of an in-coverage and same serving gNB scenario of a sidelink positioning mode 1.

FIG. 2 shows an example of an in-coverage and different gNB scenario of a sidelink positioning mode 1.

FIG. 3 shows an example of a partial-coverage scenario of a sidelink positioning mode 1.

FIGS. 4 and 5 show examples of signaling procedures based on some implementations of the disclosed technology.

FIG. 6 shows SL-PRS resource configurations configured or selected or triggered by RRC, DCI, and SCI based on some implementations of the disclosed technology.

FIG. 7 shows an example of the communication timing based on some implementations of the disclosed technology.

FIG. 8 shows an example of the communication timing based on some implementations of the disclosed technology.

FIG. 9 shows a legacy sequential relationship in DCI format 3_0.

FIG. 10 shows an example of a scenario using the measurement of CLI based on some implementations of the disclosed technology.

FIGS. 11 and 12 illustrate flowcharts showing an example method of wireless communication based on some implementations of the disclosed technology.

FIG. 13 shows an example of wireless communication including a base station (BS) and user equipment (UE) based on some implementations of the disclosed technology.

FIG. 14 shows an example of a block diagram of a portion of an apparatus based on some implementations of the disclosed technology.

### DETAILED DESCRIPTION

The disclosed technology provides implementations and examples of sidelink positioning schemes.

Two different modes may be used for sidelink resource allocation. In the mode 1 (hereinafter, “sidelink positioning mode 1”), sidelink resources are scheduled by a network device, e.g., gNB. The mode 2 is a contention based scheme with Tx UE selecting sidelink control and data resources for its transmission. Various implementations of the disclosed technology are related to the sidelink positioning mode 1.

Positioning in the sidelink resource allocation model can be applied for both in-coverage scenario and partial coverage scenario. The following is the descriptions from the related specification:

Approved SI in RAN#94 for Rel-18 positioning
Study and evaluate performance and feasibility of potential solutions for SL positioning, considering
relative positioning, ranging and absolute positioning: [RAN1, RAN2]
Evaluate bandwidth requirement needed to meet the identified accuracy requirements [RAN1]
Study of positioning methods (e.g. TDOA, RTT, AOA/D, etc) including combination of SL
positioning measurements with other RAT dependent positioning measurements (e.g. Uu based
measurements) [RAN1]
Study of sidelink reference signals for positioning purposes from physical layer perspective,
including signal design, resource allocation, measurements, associated procedures, etc, reusing
existing reference signals, procedures, etc from sidelink communication and from positioning
as much as possible [RAN1]
Study of positioning architecture and signalling procedures (e.g. configuration, measurement
reporting, etc) to enable sidelink positioning covering both UE based and network based
positioning [RAN2, including coordination and alignment with RAN3 and SA2 as required]
Note:
When the bandwidth requirements have been determined and the study of sidelink communication in unlicensed spectrum has progressed, it can be reviewed whether unlicensed spectrum can be considered in further work. Checkpoint at RAN#97 to see if sufficient information is available for this review.

For the sidelink positioning mode 1, in order to obtain and/or calculate the location information of a target UE, reference signals (e.g. sidelink positioning reference signal (SL-PRS)) are transmitted between UEs (target UE, anchor UEs/reference UEs) and the target UE is located based on the resulting measurements. During this procedure, the network can be involved in scheduling, providing assistance data, estimating the location and so on. The design of sidelink positioning mode 1, which includes position methods, protocols, procedures and UE capabilities, is unsettled and blank in the specification.

Various implementations of the disclosed technology provide designs to realize the sidelink positioning mode 1. Implementation 1 describes the positioning methods (e.g., whether the sidelink positioning is network-based or UE-based), assistance data/location information/capability transfer, and the supported scenarios for the sidelink positioning mode 1. To support the sidelink resource allocation mode 1 for different scenarios and methods, Implementation 2 introduces signaling procedures of the sidelink positioning mode 1. Implementations 3, 4 and 5 provide the detailed design of DCI and SCI mentioned in Implementation 2. Implementation 6 focuses on the congestion control for SL-PRS transmission. While Implementations 1-6 are all related to SL-PRS configuration or transmission, Implementation 7 introduces the use of SL-PRS measurements and CLI measurements to improve the positioning accuracy.

### Implementation 1

For the sidelink positioning mode 1, both of the network-based positioning method and the UE-based positioning method can be supported. For the network-based positioning, the UE may report necessary information to the network such as gNB, the location management function (LMF), etc., and the network side entity calculates the position of the UE. The network-based positioning includes the gNB-based positioning and the LMF-based positioning depending on with which network entity the UE interacts to obtain position measurement. The UE-based positioning refers to the solution where the position of the UE is calculated by the UE.

The sidelink resource allocation may begin with the request for location services for a target UE. The network device or the user device can request some location services for the user device, wherein the network device can be at least one of: 5GC (5G core network), NG-RAN node (e.g. gNB), AMF (Access and Mobility Management Function), LMF (Location Management Function), V2X application layer or V2X function. Some entity in the communication system (for example, the 5G core network system) may request the location services (e.g. positioning) for a target UE. For example, the serving AMF/gNB for a target UE may determine the need for the location service. Or, the UE can request some location service (e.g. positioning or delivery of assistance data) to the serving AMF at the NAS level. Or, the UE can request the location service (e.g. positioning or delivery of assistance data) to the serving gNB at the AS level.

Capability Transfer Between the LMF and UE, Between gNB and UE, and/or Between UEs

UE can indicate its capability to support one or more certain position methods, different aspects of a particular position method (e.g. different types of assistance request data and location information) and common features not specific to only one position method (e.g. ability to handle multiple LPP transactions). In some implementations, the UE can include the capability of CLI measurement (the measurement of CLI (Cross Link Interference)) as additional measurement information for sidelink positioning.

### Transfer of Assistance Data

The assistance data can be transferred between LMF and UE, between gNB and UE, and/or between LMF and gNB from the network. The assistance data can include SL-PRS configuration, cell information, TRP information, etc. The assistance data may include at least one of: physical cell IDs (PCIs), global cell IDs (GCIs), absolute radio frequency channel numbers (ARFCNs) of candidate NR transmission/reception points (TRPs) for measurement; timing relative to the serving (reference) TRP of candidate NR TRPs; SL-PRS configuration of candidate NR TRPs; SSB information of the TRPs (the time/frequency occupancy of SSBs); SL-PRS-only TP indication; On-Demand SL-PRS-Configurations; certain TRP configuration information; SL-PRS transmission characteristics information (SL-PRS configuration, number of transmissions, bandwidth, resource type including periodic/semi-persistent/aperiodic, pathloss reference, spatial relation information, periodicity of SL-PRS for each SL-PRS resource configuration); sidelink congestion control configuration; spatial direction information; geographical coordinates information; LOS/NLOS indicators; expected Angle Assistance information; or SL-PRS priority list.

The following three cases discuss different scenarios of transferring the assistance data based on entities through which the assistance data is transferred.

### Case 1: Transfer of Assistance Data Between LMF and UE

In some implementations, the LMF may determine the assistance data needs to be provided to the UE.

In some other implementations, the UE may firstly send a request to LMF for certain positioning assistance data. The request may be sent with assistance data request information which includes additional information concerning the UE's approximate location and serving/neighbour cells and sidelink congestion metrics such as SL channel busy ratio (CBR), SL channel occupancy ratio (CR), CRlimit. In some implementation, such assistance data request information may be provided in the Request Assistance Data message and/or in an accompanying Provide Location Information message.

In some other implementations, the LMF provides the requested assistance data in an LPP Provide Assistance Data message, if available at the LMF.

### Case 2: Transfer of Assistance Data Between gNB and UE

In some implementations, the gNB may determine the assistance data (including SL-PRS configuration) needs to be provided to the UE.

In some other implementations, the UE may firstly send a request to gNB for certain positioning assistance data. The request may be sent with assistance request information which includes additional information concerning the UE's approximate location and serving and neighbour cells. Such assistance data request information may be provided in the Request Assistance Data message and/or in an accompanying Provide Location Information message to help the gNB provide appropriate assistance data. This assistance data request information may include the UE's last known location if available, the cell IDs of the UE serving NG-RAN node and possibly neighbour NG-RAN nodes, as well as NR E-CID measurements.

In some other implementations, the gNB provides the requested assistance data in an Uu Provide Assistance Data message, if available at the gNB.

### Case 3: Transfer of Assistance Data Between LMF and gNB

In some implementations, the gNB may determine the assistance data needs to be provided to the LMF. In some other implementations, LMF requests to the gNB for certain assistance data and the gNB responds to the LMF with the assistance data.

### Transfer of Location Information

The location information transfer can occur between UEs, and/or between UEs/LMF/other gNBs and the gNB (the serving gNB of the target UE), and/or between UEs/gNB and LMF

The location information/measurement result(s) mentioned in this patent document includes at least one of:
The target UE/Rx UE reports measurements of Tx UEs/anchor UEs/reference UEs (including UE1, UE2, UE3 and etc.) and UEx(s) (UEs with no PC5 connection with the target UE).
Tx UEs and UEx(s) provide measurements transmitted from the target UE/Rx UE (Tx UEs and UEx(s) may firstly send a request for the measurement to the target UE/Rx UE). UEx(s) correspond to other UEs with no PC5 connection with the target UE.
Tx UEs provide measurements between two Tx UEs.
Tx UEs provide measurements between one Tx UE and UEx.
measurements collected from gNB for LMF or UE based positioning
measurements collected from LMF for gNB or UE based positioning
A UE list shall be provided along with other measurement elements.

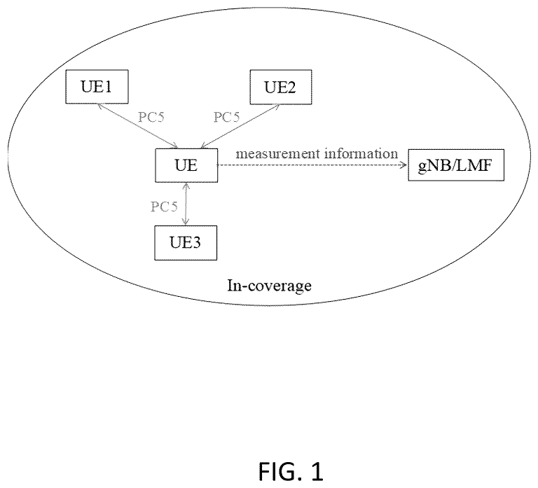

In the below, the procedure and description of the sidelink positioning mode 1 under various scenarios are discussed with reference to FIGS. 1-3. FIG. 1 shows an example of an in-coverage and same serving gNB scenario of the sidelink positioning mode 1. Referring to FIG. 1, UEs (including the target UE and other anchor UEs/reference UEs) are all under the same gNB's coverage. In FIG. 1, the UE corresponds to the target UE, and UE1, UE2, and UE 3 which are connected with the UE through PC5 communications correspond to anchor UEs/reference UEs. In this case, the position of the target UE can be calculated by the target UE or gNB or LMF. It is assumed that the anchor UEs/reference UEs know their own location, and the anchor UEs/reference UEs can be a road side unit (RSU), etc. The target UE or network (gNB/LMF) can use the relative location distance and/or angle between the target UE and anchor UEs/reference UEs to get the location information of the target UE.

For gNB-based positioning, UEs report the SL-PRS measurement results (e.g. SL-PRS-RSRP) of SL-PRS to the serving gNB for position estimation. The gNB takes the role of LMF in the legacy positioning specification which includes calculating the location, determining the positioning methods to be used, etc.

For LMF-based positioning, the LMF interacts with the serving gNB for assistance data and UE configuration data (e.g. SL-PRS configuration) and interacts with UEs in order to obtain position measurements for the target UE. The LMF may collect all sorts of information (e.g. UE positioning capability) to decide on the position methods and finally determine a single location estimate for the target UE. Additional information (e.g. the accuracy of the location estimate) may also be determined.

For UE-based positioning, the target UE collects the SL-PRS measurement results and is able to calculate and report its position.

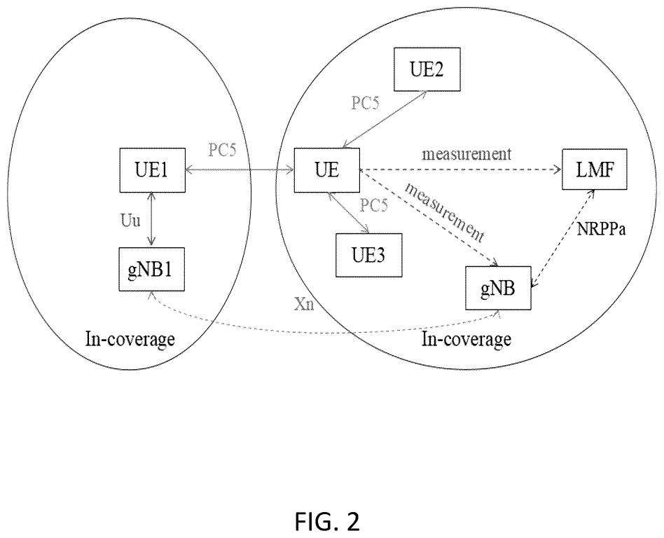

FIG. 2 shows an example of an in-coverage and different gNB scenario of a sidelink positioning mode 1. Referring to FIG. 2, UEs (including the target UE and other anchor UEs/reference UEs) are in coverages of different gNBs. In this case, the position of the target UE can be calculated by the target UE or gNB or LMF. It is assumed that the anchor UEs/reference UEs know their own locations, and the anchor UEs/reference UEs can be a road side unit (RSU), etc.

For gNB-based positioning, only when there is an Xn connection between the serving gNB of the target UE and other gNB(s), UEs can report the SL-PRS measurement results to gNB for position estimation. The serving gNB takes the role of LMF in the legacy positioning specification which includes calculating the location, deciding the positioning methods to be used, etc. The serving gNB may request the assistance data from the other gNB(s) or the other gNB(s) may report assistance data to the serving gNB.

For LMF-based positioning, the LMF interacts with the serving gNB and other gNB(s) for assitance data and UE configuration data (e.g. SL-PRS configuration) and interacts with UEs in order to obtain position measurements for the target UE. The LMF may collect all sorts of information (e.g. UE positioning capability) to decide on the position methods and finally determine a single location estimate for the target UE. Additional information (e.g. the accuracy of the location estimate) may also be determined.

For UE-based positioning, the target UE collects the SL-PRS measurement results and is able to calculate and report its position.

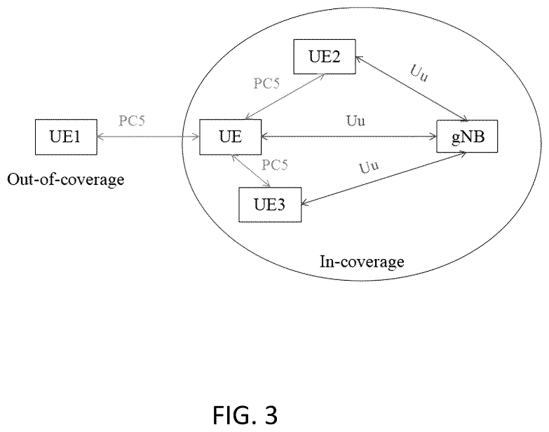

FIG. 3 shows an example of a partial-coverage scenario of a sidelink positioning mode 1. Referring to FIG. 3, some of UEs (including the target UE and other anchor UEs/reference UEs) are in-coverage and one UE is out-of-coverage. Although there is only one UE shown as being out-of-coverage, other implementations are also possible. In this case, the position of the target UE can only be calculated by the target UE. It is assumed that all the anchor UEs/reference UEs including those in-coverage and out-of-coverage know their own positions, and the anchor UEs/reference UEs can be a road side unit (RSU), etc.

For UE based positioning, the target UE collects the SL-PRS measurement results and is able to calculate and report its position.

### Implementation 2

A gNB can use higher layer signaling (e.g. RRC) to configure multiple SL-PRS resource configurations for both reception and transmission. Otherwise, the SL-PRS resource configurations may be pre-defined. A gNB may broadcast assistance data information to UEs. A gNB may provide measure information for a target UE and communicates this information to an LMF. A gNB may take the role of LMF in the legacy positioning specification which includes calculating the location, deciding the positioning methods to be used, etc.

### Signaling Procedure of Sidelink Positioning Mode 1

1. A gNB can use higher layer signaling (e.g. RRC) to configure multiple SL-PRS resource configurations for both reception and transmission, or a gNB can use higher layer signaling (e.g. RRC) to configure the range of several SL-PRS parameters. In some implementations, the SL-PRS parameters can be pre-configured. The SL-PRS configuration parameters can be preconfigured by at least one of: 5GC (5G core network), NG-RAN node (e.g. gNB), AMF, LMF, V2X application layer or V2X function.
Parameters in each PRS configuration can be at least one of: SL-PRS priority, SL-PRS resource ID, SL-PRS resource list, SL-PRS periodicity, SL-PRS resource offset, SL-PRS resource repetition factor, SL-PRS resource time gap, SL-PRS muting pattern, SL-PRS resource power, SL-PRS sequence ID, SL-PRS comb size, SL-PRS SCS, SL-PRS RB set. The SL-PRS RB set indicates the set of PRBs that are actually used for SL-PRS transmission and reception. The leftmost bit of the bitmap refers to the lowest RB index in the resource configuration, and so on. Value 0 in the bitmap indicates that the corresponding PRB is not used for SL-PRS transmission and reception while value 1 indicates that the corresponding PRB is used for SL-PRS transmission and reception)
RRC configures M1_1 PRS configurations for reception and configures M1_2 PRS configurations for transmission respectively. M1_1 can be equal to or different from M1_2.

2. DCI is used to dynamically or semi-persistently select multiple SL-PRS configurations (a subset of RRC configuration) or the range of several SL-PRS parameters for one or more UEs.
DCI can be used for a single UE for indication of either or both of SL-PRS and SL-data resource.
A common group DCI can be considered for a group of UEs.
The existing DCI format 3_0 can be reused or a new DCI format can be introduced. The DCI format 3_0 is specified in TS 38.212 clause 7.3.1.4 in Rel-16. In addition, the fields of the DCI format 3_0 are related to the TS 38.213, 38.214 and 38.331.

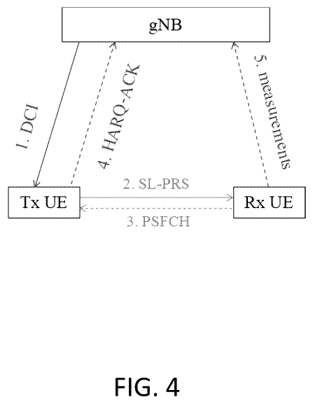

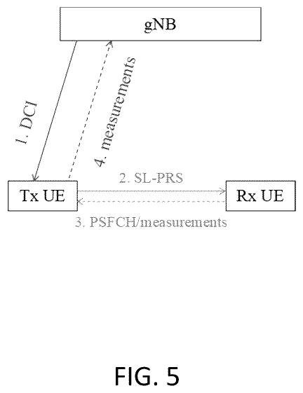

3. UEs can use SCI or/and MAC CE to report/request one or more SL-PRS configurations or the range of several SL-PRS parameters to other UE(s). In FIGS. 4 and 5 which are to be explained below, the SCI or/and MAC CE is used for scheduling and decoding of SL-PRS.
Either or both of SCI and MAC CE can be used.
The existing SCI format can be reused or a new SCI format can be introduced

4. Feedback to the network
The feedback to the network occurs depending on the scenarios, for example, based on in-coverage/partial-coverage and/or UE/LMF/gNB based positioning or not. In some implementations, for the UE-based positioning or for the partial-coverage scenario, no feedback to the network is needed.
The network can receive the measurements from Tx UEs or Rx UEs or other nodes (LMF/gNB).

FIG. 4 shows an example of a signaling procedure based on some implementations of the disclosed technology. The network can send the DCI containing SL-PRS related information, HARQ process related information, PUCCH resources and/or SL data resource related information to the Tx UE (see “1. DCI” in FIG. 4). After a time gap/SL-PRS time gap indicated by DCI, Tx UE begins the SL-PRS transmission and Rx UE can receive the SL-PRS by decoding Tx UE's SCI (scc “2. SL-PRS” in FIG. 4). If the transmission is unicast or groupcast, Rx UE may send the HARQ-ACK feedback through PSFCH to the Tx UE (see “3. PSFCH” in FIG. 4). The Tx UE can send this HARQ-ACK feedback using the PUCCH resources provided by DCI to the network (see “4. HARQ-ACK” in FIG. 4). If the Rx UE successfully receives the SL-PRS, the Rx UE may report the measurement results to the network (see “5. Measurement”).

FIG. 5 shows an example of another signaling procedure based on some implementations of the disclosed technology. The network (e.g., gNB) can send the DCI containing SL-PRS related information, HARQ process related information, PUCCH resources and/or SL data resource related information to the Tx UE (see “1. DCI” in FIG. 5). After a time gap/SL-PRS time gap indicated by DCI, Tx UE begin the SL-PRS transmission and Rx UE can receive the SL-PRS by decoding Tx UE's SCI (scc “2. SL-PRS” in FIG. 5). Rx UE may send the HARQ-ACK feedback through PSFCH or Rx UE may report the measurement result of SL-PRS (e.g. SL-PRS RSRP, RSRPP) to the Tx UE (see “3. PSFCH/measurements” in FIG. 5). If the Tx UE receives the measurements from Rx UE, Tx UE can send this measurements feedback using the PUCCH resources provided by DCI to the network (see “4. measurements” in FIG. 5).

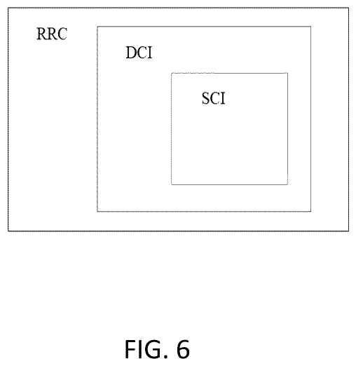

FIG. 6 shows the relative number of SL-PRS resource configurations configured/selected/triggered by RRC/DCI/SCI. A gNB can use higher layer signaling (e.g. RRC) to (pre-) configure M₁ SL-PRS resource configurations for both reception and transmission. DCI is used to dynamically or semi-persistently select M₂ SL-PRS configurations for one or more UEs. UEs can use SCI or/and MAC CE to inform/request M₃ (one or more) SL-PRS configurations to UE(s). M₁>M₂>M₃ or M₁>=M₂>=M₃ or M₁>=M₂>M₃ or M₁>M₂>=M₃

FIG. 6 can also show the value range of parameters in SL-PRS resource configuration configured/selected/triggered by RRC/DCI/SCI. A gNB can use higher layer signaling (e.g. RRC) to (pre-) configure the value range of several SL-PRS parameters for both reception and transmission. DCI is used to dynamically or semi-persistently select the value range of several SL-PRS parameters for one or more UEs. UEs can use SCI or/and MAC CE to inform/request the value range of several SL-PRS parameters to UE(s). The value range of SL-PRS parameters configured by RRC is larger or no less than the range selected by DCI. The value range of SL-PRS parameters selected by DCI is no less than or larger than those triggered by SCI.

The measurement results for sidelink positioning include at least one of: measurement list, UE pair/list, SL-PRS ID, PhysCellID, CellGlobalID, absolute radio-frequency channel number (ARFCN), TimeStamp, SL-PRS RSTD, SL-PRS RSRP, Rx-Tx time difference, SRS RSRP, angle of arrival (AoA), AdditionalPathList, TimingQuality, Additional Measurements, Los/NLos indicator, etc.

If LMF requests UE/gNB to report measurement results, response time/response time earlyfix can be configured at the NAS level together with other configurations that include location information type (location estimate or measurements); triggered reporting; periodical reporting (including reporting amount and reporting interval); accuracy request (horizontal, vertical). time indicates the maximum response time as measured between receipt of the request and transmission of a location information. Response time indicates the maximum response time as measure between the receipt of the RequestLocationInformation and the transmission of a ProvideLocationInformation as specified in the related standards (e.g., TS 37.355). Response time/response time earlyfix can also be triggered by physical layer control signaling, e.g., RRC/DCI/MAC CE/SCI.
If the unit field is absent, the value range is an integer number of seconds between 1 and 128.
If the unit field is present with enumerated value ‘ten-seconds,’ the maximum response time is given in units of 10-seconds, between 10 and 1280 seconds.
If the unit field is present with enumerated value ‘ten-milli-seconds,’ the maximum response time is given in units of 10-milli-seconds, between 0.01 and 1.28 seconds.

If gNB requests UEs to report measurement results, response time/response time earlyfix can be triggered by physical layer control signaling, e.g., RRC/DCI/MAC CE/SCI. In some implementations, other configurations can be requested by gNB, which include location information type (location estimate or measurements); triggered reporting; periodical reporting (including reporting amount and reporting interval); and/or accuracy request (horizontal, vertical).

### Implementation 3: New DCI Format

In sidelink positioning mode 1, for SL-PRS transmission, 1) dynamic grant, 2) configured grant type 1 and 3) configured grant type 2 are supported.

For sidelink dynamic grant, the SL-PRS transmission is scheduled by a DCI format [3_0]. For sidelink configured grant type 2, the configured grant is activated by a DCI format [3_0]. For sidelink configured grant type 1, the SL-PRS transmission follows the higher layer configuration.

In this implementation, a new DCI format (DCI format 3_0 or another new name of DCI format) is introduced with a new CRC scrambled by ‘SL-PRS-RNTI’ to indicate/select several SL-PRS resource configurations. Sidelink Configured Grant (SL CG) can be used for periodic SL-PRS and the new DCI format with a new CRC scrambled by ‘SL-CS-PRS-RNTI’ can be introduced to indicate/select SL-PRS resources.

The DCI can indicate time/frequency domain resources for SL-PRS, some of existing fields in DCI format 3_0 can be kept unchanged and new fields can be added. The DCI has fields that include at least one of: a SL-PRS transmission indication indicating whether or not sidelink data is transmitted, SL-PRS resource configuration index, SL-PRS frequency resource assignment, SL-PRS time resource assignment, time offset between SL-PRS transmission and a first SL data resource, SL-PRS measurement report activation/release indication, mapping relationship between data pool resource and PRS resource configuration, or feedback timing indicator, configuration index if the DCI is with CRC scrambled by SL-RNTI or SL-CS-RNTI or SL-PRS-RNTI or SL-PRS-CS-RNTI, time gap-PRS indicating time gap between a DCI reception and a first SL-PRS transmission scheduled by the DCI. The fields to be added in new DCI format for sidelink positioning depend on the configuration of SL-PRS, e.g. SL-PRS resource pool/configuration can be included in or mapped to SL data resource pool.

The size of the new DCI format can be same or different from the existing format. Moreover, the size of the new DCI format with CRC scrambled by SL-PRS-RNTI or SL-CS-PRS-RNTI is aligned. If multiple transmit resource pools are provided, zeros shall be appended to the new DCI format until the payload size is equal to the size of the new DCI format given by a transmit resource configuration, resulting in the largest number of information bits for the new DCI format.

### Example 1 (SL-PRS Resource Configuration are Included in the SL Data Resource Pool)

In this case, higher layer parameter (e.g. RRC) can be used to indicate the set of PRBs that are actually used for SL-PRS transmission and reception. The design of DCI field depends on the transmission and reception of either or both of SL-PRS and SL-data resource. An extra bit can be used to indicate whether or not the SL data is transmitted.

In some implementations, if both SL-PRS and SL data are triggered by the new DCI format, the fields provided in Example 1.1 can be activated and the fields provided in Example 1.2 can be deactivated.

In some implementations, if only SL-PRS is triggered by the new DCI format, the fields provided in Example 1.1 can be activated and the fields provided in Example 1.2 can be deactivated.

### Example 1.1 (if Both SL-PRS and SL Data are Triggered by DCI)

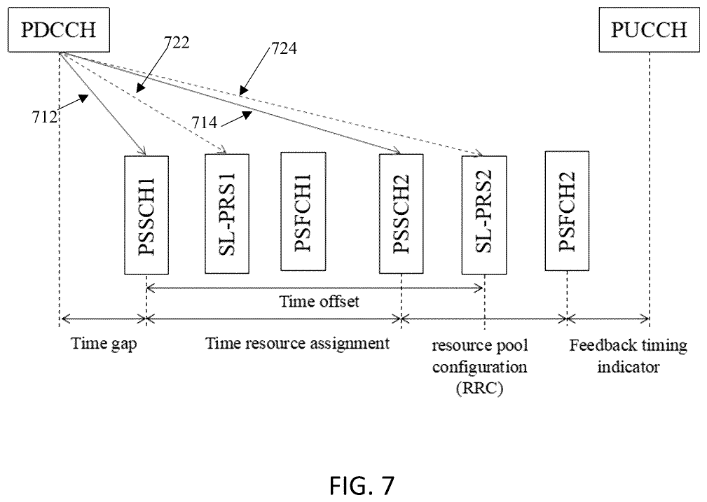

FIG. 7 shows an example of the communication timing based on some implementations of the disclosed technology. DCI allocates the resources for SL-data transmission on PSSCH 712 and 714, and SL-PRS transmission 722 and 724 and indicates some of the timing relationships. Specifically, there is a time gap between DCI reception and the first sidelink transmission scheduled by the DCI (“PSSCH1” in FIG. 7). Based on the “time offset between SL-PRS transmission and SCI format 1-A (the first SL data resource)” field in DCI, the SL-PRS transmission time is determined. The “Feedback timing indicator” indicates the slot offset between the feedback of SL data/SL-PRS from Rx UE and PUCCH reporting of the Tx UE. At least one of the fields in the following table can be introduced for the new DCI format and some of the fields can be optional.

| Field(s) | Note |
|---|---|
| SL-PRS Transmission indication | 1 bit, ‘0’ means only SL-PRS transmission, ‘1’ |
| | means both SL data and SL-PRS transmission |
| Existing fields in DCI format 3_0 | Resource pool index, Time gap, SCI format 1-A |
| | fields (time resource assignment), (optional) HARQ |
| | process number, PUCCH resource indicator |
| SL-PRS resource configuration index | When the network configures multiple SL-PRS |
| | resource configurations, SL-PRS resource/ |
| | configuration index can be introduced. The bits |
| | number of this field depends on the number of SL- |
| | PRS resource configurations for transmission |
| | configured by the higher layer parameter. |
| SL-PRS frequency resource assignment | indicate the number of contiguously allocated sub- |
| | channels for each resource and the starting sub- |
| | channel indexes of resources. If this field is not |
| | provided, SL-PRS transmission occupies the entire |
| | bandwidth configured in high layer parameter by |
| | default. |
| Time offset between SL-PRS transmission and SCI | |
| format 1-A (the first SL data resource) | |
| Configuration index | 0 bit if the UE is not configured to minitor the new |
| | DCI format with CRC scrambled by SL-CS-PRS- |
| | RNTI. |
| Counter SL-PRS assignment index | feedback can be HARQ-ACK or SL-PRS |
| | measurement report obtained from Rx UE |
| SL-PRS Measurement report | 1 bit |
| activation/release | “1” for SL-PRS measurement report activation |
| indication | “0” for SL-PRS measurement report |
| | deactivation/release. |
| Feedback timing indicator | feedback can be HARQ-ACK or SL-PRS |
| | measurement report obtained from Rx UE. |
| | DCI selects one of the RRC configured |
| | values of the PSFCH/SL-PRS measurement |
| | report to PUCCH gap |
| Padding bits, if required | for DCI size alignment |

### Example 1.2 (if Only SL-PRS is Triggered by DCI)

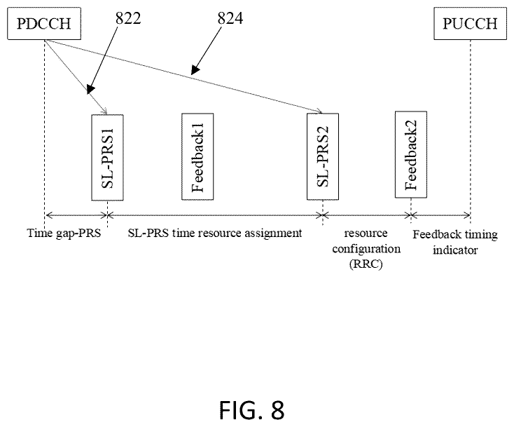

FIG. 8 shows an example of the communication timing based on some implementations of the disclosed technology. DCI only allocates the resources for SL-PRS transmission 822 and 824 and indicates some of the timing relationships. Specifically, there is a time gap between DCI reception and the first SL-PRS transmission scheduled by the DCI (“SL-PRS1” in FIG. 8). Based on the “SL-PRS time resource assignment” field in DCI, the SL-PRS transmission time is determined. The “Feedback timing indicator” indicates the slot offset between the feedback of SL-PRS from Rx UE and PUCCH reporting of the Tx UE. At least one of the fields in the following table can be introduced for the new DCI format and some of the fields can be optional.

| Field(s) | Note |
|---|---|
| SL-PRS Transmission | 1 bit, ‘0’ means only SL-PRS transmission, ‘1’ means both |
| indication | SL data and SL-PRS transmission |
| SL-PRS resource | When the network configures multiple SL-PRS resource |
| configuration index | configurations, SL-PRS resource configuration index can be |
| | introduced. The bits number of this field depends on the |
| | number of SL-PRS resource configurations for transmission |
| | configured by the higher layer parameter. |
| Time gap - PRS | indicate the time gap between DCI reception and the first |
| | SL-PRS transmission scheduled by the DCI. This field value |
| | m provide an index m + 1 into a slot offset table which is |
| | given by higher layer parameter. |
| New data indicator | 1 bit |
| PUCCH resource indicator | 3 bits |
| SL-PRS frequency resource | indicate the number of contiguously allocated sub-channels |
| assignment | for each resource and the starting sub-channel indexes of |
| | resources. If this field is not provided, SL-PRS transmission |
| | occupies the entire bandwidth configured in high layer |
| | parameter by default. |
| SL-PRS time resource | indicate time offset with respect to the first SL-PRS |
| assignment | resource |
| Configuration index | 0 bit if the UE is not configured to minitor the new DCI |
| | format with CRC scrambled by SL-CS-PRS-RNTI. |
| SL-PRS Measurement report | 1 bit |
| activation/release | “1” for SL-PRS measurement report activation |
| indication | “0” for SL-PRS measurement report deactivation/release. |
| Feedback timing indicator | feedback can be the SL-PRS measurement report obtained |
| | from Rx UE |
| | DCI selects one of the RRC configured values of the SL- |
| | PRS measurement report to PUCCH gap |
| Padding bits, if required | for DCI size alignment |

### Example 2 (if SL-PRS Resource Configuration is Configured Independently (in Carrier Frequency Level/BWP Level/Resource Pool Level) and can be Mapped to SL Data Resource Pool)

In some implementations, the recommended fields of the new DCI format are as follows. At least one of the fields in the following table can be introduced for the new DCI format and some of the fields can be optional.

| Field(s) | Note |
|---|---|
| SL-PRS resource | When the network configures multiple SL-PRS |
| configuration index | resource configurations, SL-PRS resource |
| | configuration index can be introduced. The bits |
| | number of this field depends on the number of SL- |
| | PRS resource configurations for transmission |
| | configured by the higher layer parameter. |
| Time gap - PRS | indicate the time gap between DCI reception and the |
| | first SL-PRS transmission scheduled by the DCI. |
| | This field value m provide an index m + 1 into a slot |
| | offset table which is given by higher layer |
| | parameter. |
| New data indicator | 1 bit |
| PUCCH resource indicator | 3 bits |
| SL-PRS frequency | indicate the number of contiguously allocated sub- |
| resource assignment | channels for each resource and the starting sub- |
| | channel indexes of resources. If this field is not |
| | provided, SL-PRS transmission occupies the entire |
| | bandwidth configured in high layer parameter by |
| | default. |
| SL-PRS time resource | indicate time offset with respect to the |
| assignment | first SL-PRS resource |
| mapping relationship between | Single SL-data resource pool can be associated |
| data pool resource(s) and SL- | with one or several SL-PRS resource |
| PRS configuration resource(s) | configurations; Single SL-PRS resource |
| | configuration can be associated with one or |
| | several SL-data resource pool. |
| Configuration index | 0 bit if the UE is not configured to minitor |
| | the new DCI format with CRC scrambled by |
| | SL-CS-PRS-RNTI. |
| SL-PRS Measurement report | 1 bit |
| activation/release | “1” for SL-PRS measurement report activation |
| indication | “0” for SL-PRS measurement report |
| | deactivation/release. |
| Feedback timing indicator | feedback can be the SL-PRS measurement |
| | report obtained from Rx UE |
| | DCI selects one of the RRC configured values of |
| | the SL-PRS measurement report to PUCCH gap |
| Padding bits, if required | for DCI size alignment |

### Implementation 4: Extending Existing DCI Format 3_0

In the sidelink positioning mode 1, for SL-PRS transmission, 1) dynamic grant, 2) configured grant type 1 and 3) configured grant type 2 are supported.

For sidelink dynamic grant, the SL-PRS transmission is scheduled by a DCI format 3_0. For sidelink configured grant type 2, the configured grant is activated by a DCI format 3_0. For sidelink configured grant type 1, the SL-PRS transmission follows the higher layer configuration.

In this implementation, the existing DCI format 3_0 is used for the sidelink positioning mode 1 with a CRC scrambled by ‘SL-RNTI/SL-CS-RNTI’ and SL-PRS related fields are added to dynamically indicate/select several SL-PRS resource configurations. The DCI can indicate separate time/frequency domain resources for SL data channel and SL PRS. The fields to be added in DCI format 3_0 for sidelink positioning depend on the configuration of SL-PRS. For example, the SL-PRS resource configuration can be included in or mapped to SL data resource pool. The DCI can add extra fields related to SL-PRS that include at least one of: a SL-PRS transmission indication indicating whether or not sidelink data is transmitted, SL-PRS resource configuration index, SL-PRS frequency resource assignment, SL-PRS time resource assignment, time offset between SL-PRS transmission and a first SL data resource, SL-PRS measurement report activation/release indication, mapping relationship between data pool resource and PRS resource configuration, or feedback timing indicator, configuration index if the DCI is with CRC scrambled by SL-RNTI or SL-CS-RNTI or SL-PRS-RNTI or SL-PRS-CS-RNTI, time gap-PRS indicating time gap between a DCI reception and a first SL-PRS transmission scheduled by the DCI.

Higher layer parameter (e.g. RRC) can be used to enable the sidelink positioning feature. There are three situations: only SL-PRS, only SL data, both SL-PRS and SL data are transmitted/received.

When only SL data transmitted/received, it is suggested to reuse the existing field in DCI format 3-0.

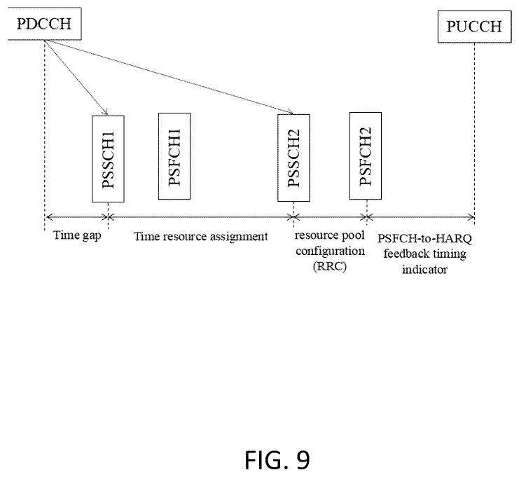

FIG. 9 shows a legacy sequential relationship in the current DCI format 3.0. When only SL data is transmitted and SL-PRS is not transmitted, the whole existing fields in DCI format 3_0 can be reused without adding any more fields.

If SL-PRS resource pool/configuration are included in the SL data resource pool, higher layer parameter (e.g. RRC) can be used to indicate the set of PRBs that are actually used for SL-PRS transmission and reception. At least one of the fields in the following table can be introduced to extend DCI format 3_0 and some of the fields can be optional.

| Field(s) | Note |
|---|---|
| Resource pool index, Time gap, HARQ process | Existing fields in DCI format 3_0 |
| number, New data indicator, Lowest index of the | |
| subchannel allocation to the initial transmission, | |
| SCI format 1-A fields(frequency and time | |
| resource assignment), PSFCH-to-HARQ | |
| feedback timing indicator, PUCCH resource | |
| indicator, Configuration index, Counter sidelink | |
| assignment index , Padding bits | |
| SL-PRS Transmission indication | 2bit |
| | 00: only SL data |
| | 01: only SL-PRS |
| | 10: both SL data and SL-PRS |
| | 11: reserved |
| | Or 1 bit: |
| | 0: only SL-PRS |
| | 1: both SL data and SL-PRS |
| | Default/empty: only SL data |
| SL-PRS resource configuration index | When the network configures multiple SL-PRS resource |
| | configurations, SL-PRS resource configuration index can |
| | be introduced. The bits number of this field depends on |
| | the number of SL-PRS resource configurations for |
| | transmission configured by the higher layer parameter. |
| Time offset between SL-PRS transmission and | If the transmission of both SL-PRS and SL data are |
| SCI format 1-A (the first SL data resource) | triggered |
| SL-PRS frequency resource assignment | indicate the number of contiguously allocated sub- |
| | channels for each resource and the starting sub-channel |
| | indexes of resources. If this filed is not provided, SL-PRS |
| | transmission occupies the entire bandwidth configured in |
| | high layer parameter by default. |
| SL-PRS time resource assignment | If only the transmission of SL-PRSis triggered |
| | indicate time offset with respect to the first SL-PRS |
| | resource |
| Time gap-PRS | If only the transmission of SL-PRS is triggered |
| | indicate the time gap between DCI reception and the first |
| | SL-PRS transmission scheduled by the DCI. This field |
| | value m provide an index m + 1 into a slot offset table |
| | which is given by higher layer parameter. |
| SL-PRS Measurement report | 1 bit |
| activation/release | “1” for SL-PRS measurement report activation |
| indication | “0” for SL-PRS measurement report deactivation/release. |
| Feedback timing indicator | feedback can be HARQ-ACK or SL-PRS measurement |
| | report obtained from Rx UE |

If SL-PRS resource pool/configuration is configured independently (in carrier frequency level/BWP level/resource pool level) and can be mapped to SL data resource pool. At least one of the fields in the following table can be introduced for DCI format 3_0 and some of the fields can be optional.

| Field(s) | Note |
|---|---|
| Resource pool index, Time gap, HARQ process | Existing fields in DCI format 3_0 |
| number, New data indicator, Lowest index of the | |
| subchannel allocation to the initial transmission, | |
| SCI format 1-A fields(frequency and time resource | |
| assignment), PSFCH-to-HARQ feedback timing | |
| indicator, PUCCH resource indicator, | |
| Configuration index, Counter sidelink | |
| assignment index, Padding bits | |
| SL-PRS resource | When the network configures multiple SL-PRS resource |
| configuration index | configurations, SL-PRS resource configuration index can |
| | be introduced. The bits number of this field depends on the |
| | number of SL-PRS resource configurations for transmission |
| | configured by the higher layer parameter. |
| Time gap-PRS | indicate the time gap between DCI reception and the first |
| | SL-PRS transmission scheduled by the DCI. This field |
| | value m provide an index m + 1 into a slot offset table which |
| | is given by higher layer parameter. |
| SL-PRS frequency resource | indicate the number of contiguously allocated sub-channels |
| assignment | for each resource and the starting sub-channel indexes of |
| | resources. If this filed is not provided, SL-PRS transmission |
| | occupies the entire bandwidth configured in high layer by |
| | default. |
| SL-PRS time resource | indicate time offset with respect to the first SL-PRS |
| assignment | resource |
| Mapping | Mapping relationship between data pool resource(s) |
| | and PRS resource(s) configuration |
| SL-PRS Measurement report | 1 bit |
| activation/release | “1” for SL-PRS measurement report activation |
| indication | “0” for SL-PRS measurement report deactivation/release. |
| Feedback timing indicator | feedback can be HARQ-ACK or SL-PRS measurement |
| | report obtained from Rx UE |

Regarding the DCI size, If multiple SL-PRS/data transmit resource pools/configurations are provided, zeros shall be appended to the DCI format 3_0 until the payload size is equal to the size of a DCI format 3_0 given by a configuration of the SL-PRS/data transmit resource pool/configuration resulting in the largest number of information bits for DCI format 3_0.

If the UE is configured to monitor DCI format 3_1 and the number of information bits in DCI format 3_0 is less than the payload of DCI format 3_1, zeros shall be appended to DCI format 3_0 until the payload size equals that of DCI format 3_1. If the UE is configured to monitor DCI format 3_0 and the number of information bits in DCI format 3_1 is less than the payload of DCI format 3_0, zeros shall be appended to DCI format 3_1 until the payload size equals that of DCI format 3_0. Due to the bit constraint of the DCI, the size of the DCI format 3_0 excluding 24-bit CRC need to be no greater than 140 bits.

### Implementation 5—Design of SCI

SCI carried on PSCCH is a 1^{st} stage SCI, which transports sidelink scheduling information. In the current specification, SCI format 1-A is used for the scheduling of PSSCH and the 2nd stage SCI on PSSCH. In this implementation, some fields of the SCI format 1-A are modified from the current specification to schedule the SL-PRS.

The following table shows the example of a SCI format 1-A based on some implementations of the disclosed technology. In the following table, the ‘priority’ field and the ‘2^{nd}-stage SCI format’ field are modified fields from those in the current specification. For example, the priority indicator of SL-PRS transmission can be introduced and the reserved bits in the field 2nd-stage SCI format can be used to indicate the new SCI format of SL-PRS. In addition, the existing 2nd-stage SCI format can be extended to trigger SL-PRS transmission or introduce new SCI format to trigger SL-PRS transmission.

Field

Priority
Frequency resource assignment
Time resource assignment
Resource reservation period
DMRS pattern
2^{nd} stage SCI format
Beta_offset indicator
Number of DMRS port
Modulation and coding scheme
Additional MCS table indicator
PSFCH overhead indication
Reserved

### Priority Field

Regarding the priority field, the priority can be integer, non-integer, or discontinuous integer, or discontinuous decimal and the priority indicator can be introduced to the SL-PRS transmission with following three options.

Option 1: The priority indicator of SL-PRS is configured in each PRS configuration.

Option 2: The priority indicator of SL-PRS is indicated in SCI format 1-A from Tx UE to Rx UE.

Option 2-1: It is suggested to reuse the current priority indicator in SCI where the codepoint of the priority indicator can be activated by MAC-CE. One codepoint corresponds to two values.

Option 2-2: A new table as shown below is introduced and each entry corresponds to a combination of priority level for SL-PRS and priority level for PSSCH. The new table can be specified in RAN1.

| | Value of | |
|---|---|---|
| | priority field | Priority |
| SL-data | 0000 | 1 |
| | 0001 | 2 |
| | 0010 | 3 |
| | 0011 | 4 |
| | 0100 | 5 |
| | 0101 | 6 |
| | 0110 | 7 |
| | 0111 | 8 |
| SL-PRS | 1000 | 1 |
| | 1001 | 2 |
| | 1010 | 3 |
| | 1011 | 4 |
| | 1100 | 5 |
| | 1101 | 6 |
| | 1110 | 7 |
| | 1111 | 8 |

The table below is another example of the new table for the priority indicator.

| | Value of | |
|---|---|---|
| | priority field | Priority |
| SL-PRS | 0000 | 1 |
| | 0001 | 2 |
| | 0010 | 3 |
| | 0011 | 4 |
| | 0100 | 5 |
| | 0101 | 6 |
| | 0110 | 7 |
| | 0111 | 8 |
| SL-data | 1000 | 1 |
| | 1001 | 2 |
| | 1010 | 3 |
| | 1011 | 4 |
| | 1100 | 5 |
| | 1101 | 6 |
| | 1110 | 7 |
| | 1111 | 8 |

Option 3: The priority indicator of SL-PRS is indicated in the 2nd-stage SCI format from Tx UE to Rx UE. For example, the reserved bits in the 2nd-stage SCI format field, which are shown in the table below, are used to indicate the new SCI format of SL-PRS.

Table 8.3.1.1-1: 2^{nd}-stage SCI formats

| Value of 2nd- | 2nd-stage |
|---|---|
| stage SCI format field | SCI format |
| 00 | SCI format 2-A |
| 01 | SCI format 2-B |
| 10 | Reserved |
| 11 | Reserved |

When a UE transmits/receives N SL-PRSs to/from one or multiple UEs, the UE only transmits or receives only a set of SL-PRS corresponding to the smallest priority field value. Also, the priority value of SL-PRS measurement feedback is the same as the priority value of the SL-PRS transmission that is associated with the SL-PRS measurements reception occasions.

2nd-Stage SCI Format Field

The 2nd-stage SCI format field can be designed by extending the existing 2nd-stage SCI format to trigger SL-PRS transmission or introducing new 2nd-stage SCI format to trigger SL-PRS transmission. The SCI includes fields that include at least one of Providing/requesting indicator, SL-PRS transmission indication indicating only SL-data, only SL-PRS or both SL-data and SL-PRS, SL-PRS priority, time offset between SL-PRS transmission and a first SL data resource, SL-PRS time resource assignment, SL-PRS frequency resource assignment, SL-PRS resource reservation period, SL-PRS measurement request indicator, SL-PRS RSRP threshold, response time, mapping relationship between data pool resource and PRS resource configuration. Different cast type(s) are supported for SL-PRS transmission, Under which conditions groupcast/unicast/broadcast can be supported.

Alt1: MAC CE and 2nd-stage SCI are used as the container of an explicit request SL-PRS transmission between UEs or the container to report the SL-PRS. MAC CE is used and it is up to UE implementation to additionally use 2nd-stage SCI. When 2nd-stage SCI and MAC CE are both used, the same resource is indicated in the 2nd-stage SCI and the MAC CE.

Alt2: MAC CE is used as the container of an explicit request SL-PRS transmission between UEs or the container to report the SL-PRS.

Alt3: The 2nd-stage SCI is used as the container of an explicit request SL-PRS transmission between UEs or the container to report the SL-PRS.

Due to the bit constraint of the 2nd-stage SCI format, the size of the 2nd-stage SCI excluding 24-bit CRC needs to be no greater than 140 bits.

Option 1: Designing the new 2nd-stage SCI format

According to Rel-16 specification, SCI format 2-A is designed to support all the cast types (including groupcast type 1), while SCI format 2-B is only for groupcast type 1 with distance-based HARQ feedback operation. It is more suitable to include SCI format 2-A in the new SCI format (SCI format 2-D) to support all the cast types. Moreover, Zone ID and Communication range requirement in SCI format 2-B can provide rough positioning/zone information and thus those two can be added in the new SCI format (referred to as SCI format 2-D). The following table shows one example of the new 2nd-stage SCI format. If SL-PRS resource configuration are included in the SL data resource pool, at least one of the fields can be introduced and some fields can be optional.

| Field | Bits |
|---|---|
| Providing/requesting indicator | 1 bit |
| SL-PRS Transmission indication | 1 bit: |
| | 0: only SL-PRS |
| | 1: both SL data and SL-PRS |
| | Default/empty: only SL data |
| SL-PRS priority | 3 bits. Value ‘000’ of Priority field corresponds to priority value ‘1’, value |
| | ‘001’ of Priority field corresponds to priority value ‘2’, and so on. |
| | Or, N bits, the priority can be integer, non-integer, or discontinuous |
| | integer, or discontinuous decimal |
| Time offset between SL-PRS | Only if the transmission of both SL-PRS and SL data are triggered, this |
| transmission and SCI format 1-A | field is activated. |
| (the first SL data resource) | |
| SL-PRS time | If only the transmission of SL-PRS is triggered |
| resource assignment | indicate time offset with respect to the first SL-PRS resource |
| SL-PRS frequency | indicate the number of contiguously allocated sub-channels for each |
| resource assignment | resource and the starting sub-channel indexes of resources. If this filed |
| | is not provided, SL-PRS transmission occupies the entire bandwidth |
| | configured in high layer parameter by default. |
| SL-PRS resource | 2^{μ} *{4, 5, 8, 10, 16, 20, 32, 40, 64, 80, 160, 320, 640, 1280, 2560, |
| reservation period | 5120, 10240} slots |
| HARQ process number | 4 bits (existing field in SCI format 2-A) |
| New data indicator | 1 bit (existing field in SCI format 2-A) |
| Redundancy version | 2 bits as defined in Table 7.3.1.1.1-2 |
| | (existing field in SCI format 2-A) |
| Source ID | 8 bits as defined in clause 8.1 of [6, TS 38.214]. |
| | (existing field in SCI format 2-A) |
| Destination ID | 16 bits as defined in clause 8.1 of [6, TS 38.214]. |
| | (existing field in SCI format 2-A) |
| HARQ feedback | 1 bit as defined in clause 16.3 of [5, TS 38.213]. |
| enabled/disabled | (existing field in SCI format 2-A) |
| indicator | |
| Cast type indicator | 2 bits (existing field in SCI format 2-A) |
| CSI request | 1 bit |
| SL-PRS measurement | 1 bit |
| request indicator | The field of HARQ process number and HARQ feedback |
| | enabled/disabled indicator shall be ignored by UE if |
| | SL-PRS measurement request indicator is included |
| SL-PRS RSRP | This threshold can be used to determine whether SL-PRS |
| threshold | feedback from Rx UE is needed. |
| Response time | indicates the maximum response time as measured between receipt of the SL- |
| | PRS measurement/location information request and transmission of |
| | measurement or location information report. |
| Zone ID | 12 bits as defined in clause 5.8.11 of [9, TS 38.331]. |
| | (existing field in SCI format 2-B) |
| Communication | 4 bits determined by higher layer parameter sl-ZoneConfigMCR-Index. |
| range requirement | (existing field in SCI format 2-B) |

If SL-PRS resource configuration is configured independently (in carrier frequency level/BWP level/resource pool level), the new 2nd-stage SCI format can be designed as shown in the following table. At least one of the fields can be introduced and some fields can be optional.

| Field | Bits |
|---|---|
| Providing/requesting indicator | 1 bit |
| SL-PRS priority | 3 bits. Value ‘000’ of Priority field corresponds to priority value ‘1’, |
| | value ‘001’ of Priority field corresponds to priority value ‘2’, and so on. |
| | Or, N bits, the priority can be integer, non-integer, or discontinuous |
| | integer, or discontinuous decimal |
| SL-PRS time | indicate time offset with respect to the first SL-PRS resource |
| resource assignment | |
| SL-PRS frequency resource | indicate the number of contiguously allocated sub-channels for each |
| assignment | resource and the starting sub-channel indexes of resources. If this filed |
| | is not provided, SL-PRS transmission occupies the entire bandwidth |
| | configured in high layer parameter by default. |
| SL-PRS resource | 2^{μ} *{4, 5, 8, 10, 16, 20, 32, 40, 64, 80, 160, 320, 640, 1280, 2560, |
| reservation period | 5120, 10240} slots |
| mapping | mapping relationship between data pool resource and PRS resource |
| | configuration |
| HARQ process number | 4 bits (existing field in SCI format 2-A) |
| New data indicator | 1 bit (existing field in SCI format 2-A) |
| Redundancy version | 2 bits as defined in Table 7.3.1.1.1-2 |
| | (existing field in SCI format 2-A) |
| Source ID | 8 bits as defined in clause 8.1 of [6, TS 38.214]. |
| | (existing field in SCI format 2-A) |
| Destination ID | 16 bits as defined in clause 8.1 of [6, TS 38.214]. |
| | (existing field in SCI format 2-A) |
| HARQ feedback | 1 bit as defined in clause 16.3 of [5, TS 38.213]. |
| enabled/disabled | (existing field in SCI format 2-A) |
| indicator | |
| Cast type indicator | 2 bits (existing field in SCI format 2-A) |
| CSI request | 1 bit (existing field in SCI format 2-A) |
| SL-PRS measurement | 1 bit |
| request indicator | The field of HARQ process number and HARQ feedback |
| | enabled/disabled indicator shall be ignored by UE if |
| | SL-PRS measurement request indicator is included |
| SL-PRS RSRP threshold | This threshold can be used to determine whether SL-PRS |
| | feedback from Rx UE is needed. |
| Response time | indicates the maximum response time as measured between receipt of the SL- |
| | PRS measurement/location information request and transmission of |
| | measurement or location information report. |
| Zone ID | 12 bits as defined in clause 5.8.11 of [9, TS 38.331]. |
| | (existing field in SCI format 2-B) |
| Communication | 4 bits determined by higher layer parameter sl-ZoneConfigMCR-Index. |
| range requirement | (existing field in SCI format 2-B) |

Option 2: Extending the existing 2nd-stage SCI format

The existing 2nd-stage SCI format can be extended as shown in the following table. At least one of the fields can be introduced and some fields can be optional.

| Field | Bits |
|---|---|
| Providing/requesting indicator | 1 bit |
| SL-PRS Transmission indication | 2bit |
| | 00: only SL data |
| | 01: only SL-PRS |
| | 10: both SL data and SL-PRS |
| | 11: reserved |
| | Or 1 bit: |
| | 0: only SL-PRS |
| | 1: both SL data and SL-PRS |
| | Default/empty: only SL data |
| SL-PRS priority | 3 bits. Value ‘000’ of Priority field corresponds to priority value ‘1’, |
| | value ‘001’ of Priority field corresponds to priority value ‘2’, and so on. |
| | Or, N bits, the priority can be integer, non-integer, or discontinuous |
| | integer, or discontinuous decimal |
| Time offset between SL-PRS | Only if the transmission of both SL-PRS and SL data are triggered |
| transmission and SCI format 1-A | |
| (the first SL data resource) | |
| SL-PRS time | If only the transmission of SL-PRS is triggered |
| resource assignment | indicate time offset with respect to the first SL-PRS resource |
| SL-PRS frequency resource | indicate the number of contiguously allocated sub-channels for each |
| assignment | resource and the starting sub-channel indexes of resources. If this filed |
| | is not provided, SL-PRS transmission occupies the entire bandwidth |
| | configured in high layer parameter by default. |
| SL-PRS resource | 2^{μ} *{4, 5, 8, 10, 16, 20, 32, 40, 64, 80, 160, 320, 640, 1280, 2560, |
| reservation period | 5120, 10240} slots |
| mapping | mapping relationship between data pool resource and PRS resource |
| | configuration |
| New data indicator | 1 bit (existing field in SCI format 2-A) |
| Redundancy version | 2 bits as defined in Table 7.3.1.1.1-2 |
| | (existing field in SCI format 2-A) |
| Source ID | 8 bits as defined in clause 8.1 of [6, TS 38.214]. |
| | (existing field in SCI format 2-A) |
| Destination ID | 16 bits as defined in clause 8.1 of [6, TS 38.214]. |
| | (existing field in SCI format 2-A) |
| HARQ feedback | 1 bit as defined in clause 16.3 of [5, TS 38.213]. |
| enabled/disabled | (existing field in SCI format 2-A) |
| indicator | |
| Cast type indicator | 2 bits (existing field in SCI format 2-A) |
| CSI request | 1 bit (existing field in SCI format 2-A) |
| SL-PRS measurement | 1 bit |
| request indicator | The field of HARQ process number and HARQ feedback |
| | enabled/disabled indicator shall be ignored by UE |
| | if SL-PRS measurement request indicator is included |
| SL-PRS RSRP | This threshold can be used to determine whether SL-PRS |
| threshold | feedback from Rx UE is needed. |
| Response time | indicates the maximum response time as measured between receipt of the SL- |
| | PRS measurement/location information request and transmission of |
| | measurement or location information report. |
| Zone ID | 12 bits as defined in clause 5.8.11 of [9, TS 38.331]. |
| | (existing field in SCI format 2-B) |
| Communication | 4 bits determined by higher layer parameter sl-ZoneConfigMCR-Index. |
| range requirement | (existing field in SCI format 2-B) |

The fields ‘SL-PRS RSRP threshold,’ ‘Zone ID,’ and ‘Communication range requirement’ are related to the measurement report:

RSRP based mechanism: Only when the SL-PRS RSRP is higher than the ‘SL-PRS RSRP threshold’, the Rx UE need to report the SL-PRS measurements.

Distance based mechanism: Only when the communication requirement is met according to ‘Zone ID’ and ‘Communication range requirement’, the Rx UE need to report the SL-PRS measurements.

RSRP and distance based mechanism: when both SL-PRS RSRP and the communication requirement are met, the Rx UE need to report the SL-PRS measurements.

SL-PRS RSRP threshold can also be configured in higher layer signaling: MAC/DCI/RRC/NAS signaling.

### Implementation 6

In the current specification, the sidelink congestion control is used in the sidelink positioning mode 2. There are mapping relationship between PSSCH transmission parameter (such as MCS, PRB number, retransmission number, MaxTxPower, CR limit), CBR ranges and priority ranges. Several parameters including CBR, CR/CRlimit, SL RSSI are related to the congestion control according to TS 38.215. The SL-PRS congestion control is usually used in the sidelink positioning mode 2 when the network cannot configure the transmission parameter. In this case, the UE needs to measure the congestion ratio of the channel and based on its own transmission priority to decide how many resources the transmission will occupy.

In the sidelink positioning mode 1, the sidelink transmission parameter is decided/configured by the network. UE can also report the CBR measurements to gNB. In this implementation, the following items with regard to the SL-PRS congestion control are discussed:
SL-PRS congestion control parameters if needed: definition, value range, measurement window size, etc.
Define the SL-PRS transmission parameters related to congestion control.
Define the SL-PRS priority configuration related to congestion control.
For congestion control, how can we balance the SL data transmission and SL-PRS transmission?
Congestion control for mode 1 sidelink positioning

Item 1: SL-PRS congestion control parameters including at least one of the following parameter(s):

| Parameter | Description |
|---|---|
| SL-PRS CBR | SL-PRS CBR measured in slot n is defined as the portion of sub- |
| | channels in the SL-PRS resource configuration whose SL-PRS RSSI |
| | measured by the UE exceed a (pre-)configured threshold (e.g.sl-prs- |
| | ThreshS-RSSI-CBR-r16 INTEGER (0..45)) sensed over a SL-PRS CBR |
| | measurement window [n − a, n − 1], wherein a is equal to 100 or 100 · 2^{μ} |
| | slots(same value as SL data CR) or other values different from SL data |
| | CR(e.g. 1000/1000 · 2^{μ}slots), according to higher layer parameter sl-prs- |
| | Time WindowSizeCBR. |
| | The SL-PRS CBR measurement window can indicate continuous or |
| | discontinuous range or only measure those slots which have SL-PRS |
| | configuration. |
| SL-PRS CR | SL-PRS CR evaluated at slot n is defined as the total number of sub- |
| | channels used for its transmissions in slots [n − a, n − 1] and granted in slots |
| | [n, n + b] divided by the total number of configured sub-channels in the |
| | SL-PRS transmission configuration over [n − a, n + b]. |
| | Note: a is a positive integer and b is 0 or a positive integer; a and b are |
| | determined by UE implementation with a + b + 1 = 1000/1000 · 2^{μ} |
| | slots(same value as SL data CR) or other values different from SL data |
| | CR(e.g. 10240/10240 · 2^{μ}slots), according to higher layer parameter (e.g. |
| | sl-prs-TimeWindowSizeCR), b < (a + b + 1)/2, and n + b shall not exceed the |
| | last transmission opportunity of the grant for the current transmission. |
| | The SL-PRS CR window can indicate continuous or discontinuous range |
| | or only measure those slots which have SL-PRS configuration. |
| SL-PRS CRₗᵢₘᵢₜ | the maximum limit on the SL-PRS occupancy ratio |
| SL-PRS RSSI | SL-PRS RSSI is defined as the linear average of the total received power |
| | (in [W]) observed in the configured sub-channel in OFDM symbols of a |
| | slot configured for SL-PRS. |

Item 2: SL-PRS transmission parameters related to congestion control

SL-PRS transmission parameters can be at least one of the following: range of SL-PRS MCS value, range of the number of SL-PRS sub-channels, maximum SL-PRS (re) transmission number, SL-PRS MaxTxPower, SL-PRS CRlimit, SL-PRS periodicity, SL-PRS repetition factor, number of SL-PRS symbols within a slot, SL-PRS muting pattern.

Item 3: SL-PRS priority configuration related to congestion control

The detailed descriptions (including tables) can be referred to the Implementation 5 as discussed above. The following options are available for the SL-PRS priority configuration:

Option 1: The priority indicator of SL-PRS is configured in each PRS configuration

Option 2: The priority indicator of SL-PRS is indicated in SCI format 1-A from Tx UE to Rx UE

Option 2-1: It is suggested to reuse the current priority indicator in SCI where the codepoint of the priority indicator can be activated by MAC-CE. One codepoint corresponds to two values.

Option 2-2: A new table is introduced and each entry corresponds to a combination of priority level for SL-PRS and priority level for PSSCH. The new table can be specified in RAN1

Option 3: The priority indicator of SL-PRS is indicated in the 2nd-stage SCI format from Tx UE to Rx UE.

Item 4: Mapping between the transmission parameter, congestion control metrics and priority range

During the UE resource selection procedure, based on the measured CBR or/and SL-PRS CBR, UE can determine the CBR range. The CBR measurement result and the transmission priority (SL data or/and SL-PRS) are combined and the corresponding transmission parameter (SL data or/and SL-PRS) can be further determined. The following options are available:

### Option 1

SL-PRS transmission parameter and SL data transmission parameter are separately determined based on different CBR value and priority value. In some implementations, there are mapping relationship between SL-PRS transmission parameter, SL-PRS CBR ranges and SL-PRS priority ranges (not including SL data CBR and SL data priority). In some implementations, there are mapping relationship between SL data transmission parameter, SL data CBR ranges and SL data priority ranges (not including SL-PRS CBR and SL-PRS priority).

### Option 2

There are mapping relationship between SL-PRS transmission parameter, SL-PRS CBR ranges and SL-PRS priority ranges (not including SL data CBR and SL data priority). There are mapping relationship between SL data transmission parameter, SL data CBR ranges, SL data priority ranges, SL-PRS CBR and SL-PRS priority.

### Option 3

There are mapping relationship between SL-PRS transmission parameter, SL-PRS CBR ranges, SL-PRS priority ranges, SL data CBR and SL data priority. There are mapping relationship between SL data transmission parameter, SL data CBR ranges, SL data priority ranges, SL-PRS CBR and SL-PRS priority.

### Option 4

There are mapping relationship between SL-PRS transmission parameter, SL-PRS CBR ranges, SL-PRS priority ranges, SL data CBR and SL data priority. There are mapping relationship between SL data transmission parameter, SL data CBR ranges, SL data priority ranges, SL-PRS CBR and SL-PRS priority.

If the UE needs to combine both the SL-PRS CBR measurement result and SL data CBR measurement result to finally decide the SL-PRS transmission parameter and/or SL data transmission parameter. The CBR-combo range can be as follows:

$$CBR - combo = x * SL - PRS CBR + ( 1 - x ) SL data CBR ( where 0 < x < 1 )$$

The value of x can be configured in NAS layer or RRC, DCI, SCI, MAC CE, etc. Or the value of x can be determine by UE implementation.

If the SL-PRS CBR measurement window size (NSL-PRS) is different from SL data CBR measurement window size. The CBR-combo range of SL-PRS can be as follows:

$$CBR - combo - SL - PRS = {N}_{SL - PRS} * ( 1 / {N}_{SL - PRS} * x * SL - PRS CBR + 1 / {N}_{SL data} * ( 1 - x ) * SL data CBR )$$

In the equation above, 0<x<1 is satisfied. The value of x can be configured in NAS layer or RRC, DCI, SCI, MAC CE, etc. Or, the value of x can be determine by UE implementation. The N_{SL data} is the number of slots of SL data measurement window that overlaps with SL-PRS CBR measurement window.

If the SL-PRS CBR measurement window size is different from SL data CBR measurement window size (N_{SL data}). The CBR-combo range of SL data can be as follows:

$$CBR - combo - SLdata = {N}_{SL data} * ( 1 / {N}_{SL - PRS} * x * SL - PRS CBR + 1 / {N}_{SL data} * ( 1 - x ) * SL data CBR )$$

In the equation above, 0<x<1 is satisfied. The value of x can be configured in NAS layer or RRC, DCI, SCI, MAC CE, etc. Or, the value of x can be determine by UE implementation. The NSL-PRS is the number of slots of SL data measurement window that overlaps with SL data CBR measurement window.

Item 5: Congestion control for mode 1 sidelink positioning

SL-PRS congestion control can be used for mode 2 sidelink positioning resource selection. For the sidelink positioning mode 1, the UE can send a RRC request, or DCI request, or MAC CE request, or other requests (e.g. location request, assistance data request) to gNB for SL-PRS resource configuration. CBR measurements are provided along with the request and send to gNB. In some implementations, the gNB can control the SL-PRS configurations/or range of several parameters to be configured to UE.

### Implementation 7

The measurement of CLI (Cross Link Interference) can be used as an additional measurement information for the sidelink positioning. For the CLI measurements, a measurement object indicates the frequency/time location of SRS resources and/or CLI-RSSI (CLI Received signal strength indicator) resources, and subcarrier spacing of SRS resources to be measured.

In some implementations, the network may configure the UE to report the following CLI measurement information based on SRS resources:
Measurement results per SRS resource;
SRS resource(s) indexes.

In some implementations, the network may configure the UE to report the following CLI measurement information based on CLI-RSSI resources:
Measurement results per CLI-RSSI resource;
CLI-RSSI resource(s) indexes.

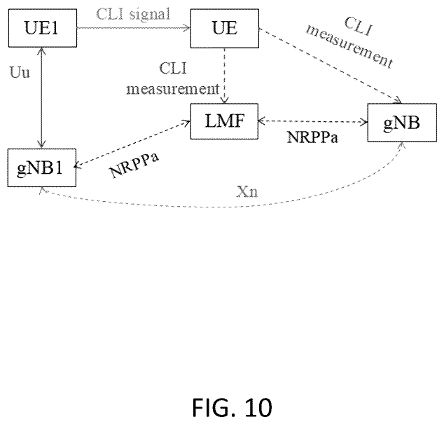

FIG. 10 shows an example of a scenario using the measurement of CLI based on some implementations of the disclosed technology. The LMF can send a request to gNB for both SL-PRS and CLI reference signal (SRS/CLI-RSSI) resources information and activates positioning. In some other implementations, for UE-based positioning, the UE can also send a request to gNB for both SL-PRS and CLI reference signal (SRS/CLI-RSSI) resources information and activates positioning.

In some implementations, the gNB can trigger the SL-PRS and SRS/CLI-RSSI transmission and configure the UE to report the measurements including UE ID/UE pair ID, SL-PRS measurement results (SRS reference signal received power, SRS-RSRP), SL-PRS resource index, measurement results per SRS resource, SRS resource(s) indexes, measurement results per CLI-RSSI resource, CLI-RSSI resource(s) indexes. As shown in FIG. 10, when there is an Xn connection between the serving gNB of the target UE/victim UE and the gNB1/neighbouring gNB of the UE1/interference UE, the gNB can obtain the UE ID of the interference UE or the UE pair ID.

In some implementation, the LMF can trigger the UE to report the measurements including UE ID/UE pair ID, SL-PRS measurement results (SRS reference signal received power, SRS-RSRP), SL-PRS resource index, measurement results per SRS resource, SRS resource(s) indexes, measurement results per CLI-RSSI resource, CLI-RSSI resource(s) indexes. As shown in FIG. 10, when there is a connection between LMF and those two gNBs, LMF can obtain the UE ID of the interference UE or the UE pair ID from the gNB1/neighbouring gNB of the UE1/interference UE through NRPPa.

In some implementations, the LMF can obtain the measurement results from gNB (including the serving gNB and other gNB), or from UEs. In some implementations, the gNB/LMF can also send the measurement results to the UE (it has the capability to calculate the location)

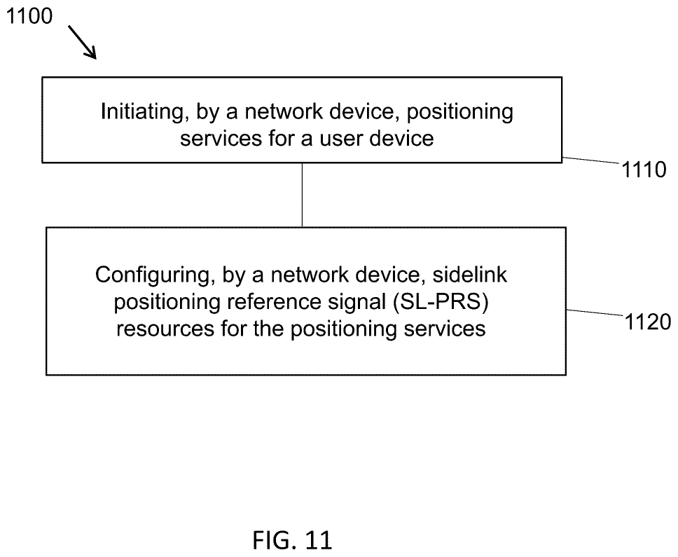

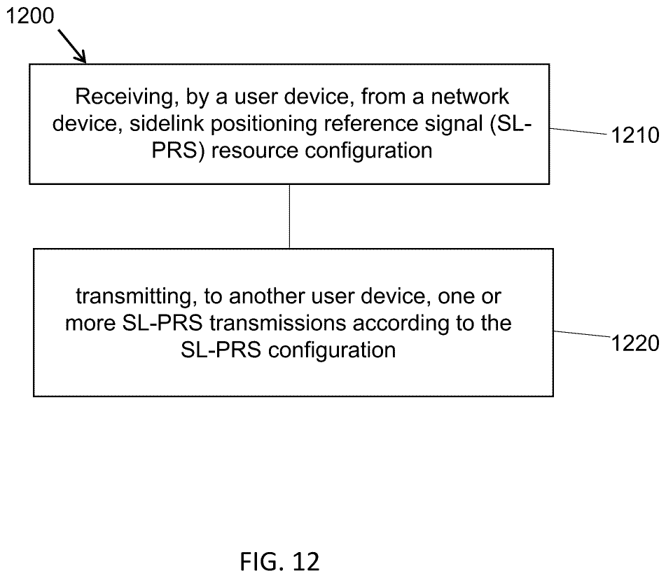

FIGS. 11 and 12 illustrate flowcharts showing example methods of wireless communication based on some implementations of the disclosed technology.

The method 1100 as shown in FIG. 11 includes initiating 1110, by a network device, positioning services for a user device. The method 1100 further includes configuring 1120, by a network device, sidelink positioning reference signal (SL-PRS) resources for the positioning services.

The method 1200 as shown in FIG. 12 includes receiving 1210, by a user device, from a network device, sidelink positioning reference signal (SL-PRS) resource configuration. The method 1200 further includes transmitting 1220, to another user device, one or more SL-PRS transmissions according to the SL-PRS configuration.

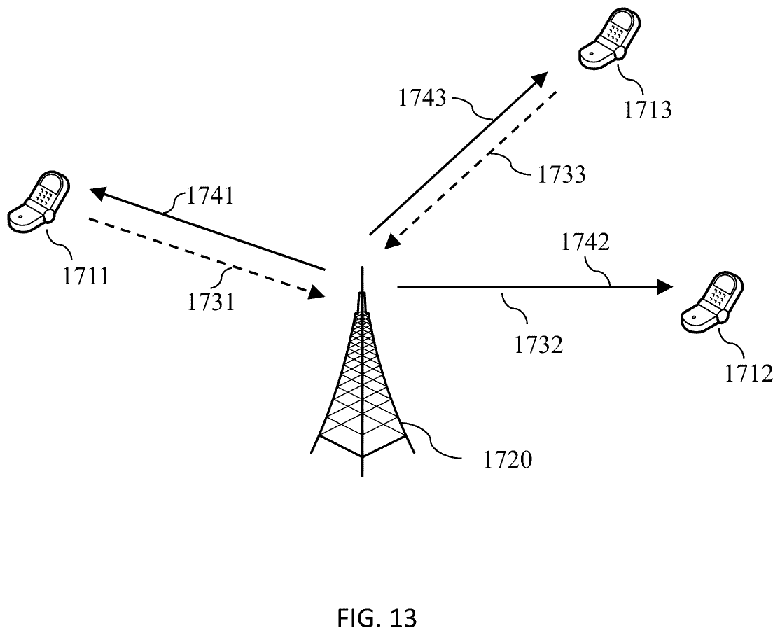

The implementations as discussed above will apply to a wireless communication. FIG. 13 shows an example of a wireless communication system (e.g., a 5G or NR cellular network) that includes a base station 1720 and one or more user equipment (UE) 1711, 1712 and 1713. In some embodiments, the UEs access the BS (e.g., the network) using implementations of the disclosed technology 1731, 1732, 1733), which then enables subsequent communication (1741, 1742, 1743) from the BS to the UEs. The UE may be, for example, a smartphone, a tablet, a mobile computer, a machine to machine (M2M) device, an Internet of Things (IoT) device, etc.

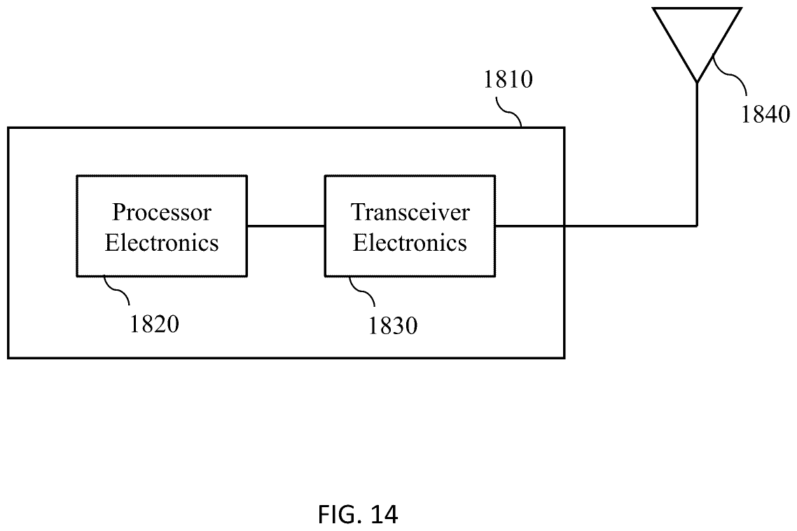

FIG. 14 shows an example of a block diagram representation of a portion of an apparatus. An apparatus 1810 such as a base station or a user device which may be any wireless device (or UE) can include processor electronics 1820 such as a microprocessor that implements one or more of the techniques presented in this document. The apparatus 1810 can include transceiver electronics 1830 to send and/or receive wireless signals over one or more communication interfaces such as antenna 1840. The apparatus 1810 can include other communication interfaces for transmitting and receiving data. The apparatus 1810 can include one or more memories (not explicitly shown) configured to store information such as data and/or instructions. In some implementations, the processor electronics 1820 can include at least a portion of transceiver electronics 1830. In some embodiments, at least some of the disclosed techniques, modules or functions are implemented using the apparatus 1810.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1-20. (canceled)

21. A method of wireless communication, comprising:
receiving, by a user device, from a network device, a high layer signaling configuring a plurality of sidelink positioning reference signal (SL-PRS) configurations;
receiving, by the user device, from the network device, a downlink control information (DCI) indicating a subset of the plurality of SL-PRS configurations, wherein the DCI indicates an SL-PRS resource configuration index, a SL-PRS time resource assignment, and a time gap between a DCI reception and a first SL-PRS transmission scheduled by the DCI; and
transmitting, to another user device, SL-PRS transmissions based on the subset of the plurality of SL-PRS configurations.

22. The method of claim 21, further comprising:
transmitting, by the user device, to the another user device, sidelink control information (SCI) indicating at least one SL-PRS configuration from the subset of the plurality of SL-PRS configurations.

23. The method of claim 21, wherein the DCI is with cyclic redundancy check (CRC) scrambled by SL-PRS-CS-RNTI and further indicates a configuration index.

24. The method of claim 22, wherein the SCI further indicates SL-PRS priority, SL-PRS time resource assignment, and SL-PRS resource reservation period associated with the at least one SL-PRS configuration.

25. The method of claim 22, wherein the SCI further comprises a requesting indicator.

26. The method of claim 21, wherein each of the plurality of SL-PRS configurations comprises at least one of following parameters:
SL-PRS resource ID,
SL-PRS resource list,
SL-PRS periodicity,
SL-PRS resource power,
SL-PRS comb size,
a maximum SL-PRS transmission number,
a SL-PRS maximum transmission power,
a limit of SL-PRS channel occupancy ratio (CR), or
a mapping relationship between SL-PRS transmission parameter, SL-PRS CBR ranges and SL-PRS priority ranges.

27. The method of claim 21, further comprising: reporting, by the user device, to the network device, SL-PRS CBR measurements.

28. A method of wireless communication, comprising:
transmitting, by a network device, to a user device, a high layer signaling configuring a plurality of sidelink positioning reference signal (SL-PRS) configurations; and
transmitting, by the network device, to the user device, a downlink control information (DCI) indicating a subset of the plurality of SL-PRS configurations, wherein the DCI indicates an SL-PRS resource configuration index, a SL-PRS time resource assignment, and a time gap between a DCI reception and a first SL-PRS transmission scheduled by the DCI, and
wherein SL-PRS transmissions are transmitted from the user device to another user device based on the subset of the plurality of SL-PRS configurations.

29. The method of claim 28, wherein sidelink control information (SCI) indicating at least one SL-PRS configuration from the subset of the plurality of SL-PRS configurations is transmitted from the user device to the another user device.

30. The method of claim 29, wherein the SCI further indicates SL-PRS priority, SL-PRS time resource assignment, and SL-PRS resource reservation period associated with the at least one SL-PRS configuration.

31. An apparatus of wireless communication, the apparatus comprising at least one processor operating as a user device and configured to:
receive, from a network device, a high layer signaling configuring a plurality of sidelink positioning reference signal (SL-PRS) configurations;
receive, from the network device, a downlink control information (DCI) indicating a subset of the plurality of SL-PRS configurations, wherein the DCI indicates an SL-PRS resource configuration index, a SL-PRS time resource assignment, and a time gap between a DCI reception and a first SL-PRS transmission scheduled by the DCI;
transmit, to another user device, SL-PRS transmissions based on the subset of the plurality of SL-PRS configurations.

32. The apparatus of claim 31, wherein the at least one processor is further configured to transmit, to the another user device, sidelink control information (SCI) indicating at least one SL-PRS configuration from the subset of the plurality of SL-PRS configuration.

33. The apparatus of claim 31, wherein the DCI is with cyclic redundancy check (CRC) scrambled by SL-PRS-CS-RNTI and further indicates a configuration index.

34. The apparatus of claim 32, wherein the SCI further indicates SL-PRS priority, SL-PRS time resource assignment, and SL-PRS resource reservation period associated with the at least one SL-PRS configuration.

35. The apparatus of claim 32, wherein the SCI further comprises a requesting indicator.

36. The apparatus of claim 31, wherein each of the plurality of SL-PRS configurations comprises at least one of following parameters:
SL-PRS resource ID,
SL-PRS resource list,
SL-PRS periodicity,
SL-PRS resource power,
SL-PRS comb size,
a maximum SL-PRS transmission number,
a SL-PRS maximum transmission power,
a limit of SL-PRS channel occupancy ratio (CR), or
a mapping relationship between SL-PRS transmission parameter, SL-PRS CBR ranges and SL-PRS priority ranges.

37. The apparatus of claim 31, wherein the at least one processor is further configured to report, to the network device, SL-PRS CBR measurements.

38. An apparatus of wireless communication, the apparatus comprising at least one processor operating as a network device and configured to:
transmit, to a user device, a high layer signaling configuring a plurality of sidelink positioning reference signal (SL-PRS) configurations;
transmit, to the user device, a downlink control information (DCI) indicating a subset of the plurality of SL-PRS configurations, wherein the DCI indicates an SL-PRS resource configuration index, a SL-PRS time resource assignment, and a time gap between a DCI reception and a first SL-PRS transmission scheduled by the DCI, and
wherein SL-PRS transmissions are transmitted from the user device to another user device based on the subset of the plurality of SL-PRS configurations.

39. The apparatus of claim 38, wherein sidelink control information (SCI) indicating at least one SL-PRS configuration from the subset of the plurality of SL-PRS configurations is transmitted from the user device to the another user device.

40. The apparatus of claim 39, wherein the SCI further indicates SL-PRS priority, SL-PRS time resource assignment, and SL-PRS resource reservation period associated with the at least one SL-PRS configuration.
